(19) United States
(12) Patent Application Publication
(10) Pub. No.: US 2023/0108043 A1
(43) Pub. Date: Apr. 6, 2023

(54) NOVEL CEMENT, CONCRETE, MORTAR AND GROUT EMBODIMENTS AND METHODS FOR MANUFACTURE AND PLACEMENT

(71) Applicant: Christopher Alfred Carlson, Salt Lake City, UT (US)

(72) Inventor: Christopher Alfred Carlson, Salt Lake City, UT (US)

(21) Appl. No.: 17/885,422

(22) Filed: Aug. 10, 2022

Related U.S. Application Data
(60) Provisional application No. 63/251,415, filed on Oct. 1, 2021.

(51) Int. Cl. C04B 28/18; C04B 22/06; C04B 22/14; C04B 18/02; C04B 14/16; C04B 14/18; C04B 40/00

(52) U.S. Cl. CPC C04B 28/18; C04B 22/064; C04B 22/148; C04B 18/027; C04B 14/16; C04B 14/18; C04B 40/0046; C04B 2111/00146

(57) ABSTRACT

Novel cement, concrete, mortar and grout embodiments for construction. The materials are produced through SCM and quicklime aqueous cement formation reactions. A novel cement is also presented that can be used to form improved concrete, mortar and grout placements. Several novel concrete embodiments are presented that can be used with any aggregate, and for any construction application; including saltwater marine placements.

### CROSS-REFERENCE TO RELATED APPLICATIONS

This application claims priority from the U.S. provisional patent application Ser. No. 63/251,415, filed on Oct. 1, 2021, which is incorporated herein by reference in its entirety.

### FIELD OF INVENTION

The current invention relates to novel cementitious materials for use in construction, and more particularly, improved cement, concrete, mortar and grout embodiments.

### BACKGROUND

Portland cement is the most common type of cementitious binder used around the world and is a basic ingredient in concrete, mortar, and grout. Generally, Portland cement is manufactured by burning and grinding a mixture of limestone and clay. The manufacture of Portland cement has a significant negative impact on the environment; it is the third largest industrial source of pollution worldwide. Portland cement is dense and difficult to dissolve. Moreover, Portland cement concrete is susceptible to corrosion and dimensionally unstable. Portland cement mortar can damage soft brick construction, effloresce, and lose cohesion. Portland cement grout segregates easily and often fails to gain strength. Because of the aforementioned drawbacks and other limitations with known types of cement; standard concrete, mortar and grout placements have short service lives. Landfills are overflowing with demolished concrete that cannot be recycled because of alkali silica reaction corrosion (ASR). Reactive aggregate can cause ASR in concrete, and most of the available aggregate is reactive, therefore non-reactive aggregate is becoming scarce and expensive. Non-reactive aggregate is often transported long distances for infrastructure projects that demand a longer service life, thereby increasing pollution, congestion and heavy truck traffic.

Supplemental cementitious material (SCM) such as fly ash, densified silica fume, blast furnace slag, rice husk ash, and natural pozzolans are substituted for Portland cement, in blended cement concrete. This can improve corrosion resistance and dimensional stability. However, due to strict pollution guidelines and improved combustion processes, usable man-made SCM are becoming scarce and expensive. Furthermore, fly ash and slag can contain toxic heavy metals. Natural pozzolans are inexpensive and non-toxic, but they do not have ASTM guidelines for use in blended cement concrete, which can cause liability issues.

There currently exists a need for novel cementitious materials that are devoid of the aforementioned drawbacks of standard and blended concrete, mortar and grout.

### SUMMARY OF THE INVENTION

The following presents a simplified summary of one or more embodiments of the current invention in order to provide a basic understanding of such embodiments. This summary is not an extensive overview of all contemplated embodiments and is intended to neither identify key or critical elements of all possible embodiments nor delineate the scope of any or all embodiments. Its sole purpose is to present some concepts of one or more embodiments in a simplified form as a prelude to the more detailed descriptions that are presented later.

The principal object of the current invention is therefore to provide novel cement, concrete, mortar and grout embodiments, devoid of the drawbacks of the prior art.

It is another object of the current invention that the novel cement, concrete, mortar and grout absorb more greenhouse gasses during cure than are created during manufacture and placement, and the novel cement embodiments can be completely recycled.

It is another object of the current invention that reactive aggregate is preferred for most embodiments, and reactive mine and industrial wastes can be mitigated as aggregate.

It is another object of the current invention that the novel concrete formulations can be adjusted to accommodate any size or type of aggregate, and for any construction application, including saltwater marine placements.

It is another object of the current invention that the novel cement, concrete, mortar and grout are light, homogeneous, waterproof and exhibit improved tensile strength.

It is another object of the current invention that the novel cement, concrete, mortar and grout embodiments can be mixed, placed and cured using industry standard equipment, additives, modifiers and practices.

It is another object of the current invention to disclose novel mixing, placement and curing methods to provide improved concrete, mortar and grout placements.

It is the final object of the current invention to disclose novel concrete formulations that can reach load-bearing strength in 28 days, then continue to gain strength well after 28 days; to provide optimized processing, efficacy and properties.

Disclosed are novel hydraulic cement embodiments for construction that are prepared by a method comprising the steps of adding calcium oxide, aluminum sulfate, sodium hydroxide and SCM, with mixing, to obtain a cementitious mixture, then adding water to the cementitious mixture to initiate an exothermic cement formation reaction. The composition contains by weight, SCM: 50-90%, calcium oxide: 5-50%, aluminum sulfate: 2-20%, and sodium hydroxide: 1-10%, wherein the SCM is selected from a group consisting of fly ash, ground blast furnace slag, silica fume, pumice, zeolite, volcanic tuff, diatomaceous earth, perlite, vermiculite, pozzolans, vitreous materials, and combinations thereof. Calcium oxide is selected from a group consisting of quicklime, magnesium oxide, dolomitic quicklime, lime, lyme, pulverized quicklime, micronized calcium oxide, technical grade calcium oxide, pharmaceutical grade calcium oxide and any type or form of calcium oxide or combination thereof. Distilled water, tap water, spring water, municipal water, reverse osmosis water, purified water, brackish water, or almost any other type of significantly clean and clear water can be added. The cementitious mixture to water ratio by weight: 0.2-2. The aqueous cement formation reaction is mixed for 1-100 minutes, covered, sequestered for 1-100 day, uncovered, dehydrated and sized to 1-100 microns prior to use as cement.

Disclosed are concrete, mortar and grout embodiments for construction that are prepared by a method comprising the steps of adding the novel cement, aggregate and water. Soft aggregate can be any size, it is selected from a group that includes pumice, terra cotta, chalkstone, zeolite, low-fired brick, sea shells, combinations of these materials, or any other clean aggregate with a compressive strength of generally 1000 psi or less. Hard aggregate must be smaller than % inch, it is selected from a group that consists of limestone, granite, basalt, expanded shale, scoria or any other type or combination of standard or lightweight aggregate with a compressive strength of generally 2000 psi or more. The aggregate to cement ratio by weight: 0-10. Distilled water, tap water, spring water, municipal water, reverse osmosis water, purified water, brackish water, or almost any other type of significantly clean and clear water is added. The water to cement ratio by weight: 0.2-2. The novel cement, concrete, mortar and grout embodiments can be mixed, placed and cured using industry standard equipment, additives, modifiers and practices. And, they mix, place, cure and gain strength similar to standard concrete, mortar and grout.

Disclosed are novel concrete embodiments for construction that are prepared by a method comprising the steps of adding calcium oxide, aluminum sulfate, aluminum hydroxide, sodium hydroxide, expanded perlite fines, and SCM, with mixing, to obtain a dry cementitious mixture; and adding aggregate to the mixture. The cementitious mixture contains by weight, SCM: 50-90%, calcium oxide: 5-50%, aluminum sulfate: 2-20%, and an aluminum hydroxide, sodium hydroxide and expanded perlite fines premixture: 1-15%, wherein the SCM is selected from a group consisting of fly ash, ground blast furnace slag, silica fume, pumice, zeolite, volcanic tuff, diatomaceous earth, perlite, vermiculite, pozzolans, vitreous materials, and combinations thereof. Calcium oxide is selected from a group consisting of quicklime, magnesium oxide, dolomitic quicklime, lime, lyme, pulverized quicklime, micronized calcium oxide, technical grade calcium oxide, pharmaceutical grade calcium oxide and any type or form of calcium oxide or combination thereof. The aluminum hydroxide, sodium hydroxide and expanded perlite fines stoichiometry in the premixture can be adjusted to accommodate any aggregate, and for any construction application, including saltwater marine placements. The ingredients are combined less than 10 days prior to aggregate and water addition. The aggregate to cementitious mixture ratio by weight: 0-10.

Disclosed are methods for conducting novel aqueous concrete formation reactions. The cementitious mixture is combined with aggregate just prior to water addition; to avoid premature reactions. Distilled water, tap water, spring water, municipal water, reverse osmosis water, purified water, brackish water, or almost any other type of significantly clean and clear water is added. The water to cementitious material ratio by weight: 0.2-2. The novel concrete embodiments can be mixed, placed and cured using industry standard equipment, additives, modifiers and practices. And, they mix, place, cure and gain strength similar to standard concrete, mortar and grout; on land.

### DETAILED DESCRIPTION

Subject matter will now be described more fully hereinafter, however, the subject matter can be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as methods, compositions, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an”, and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The novel hydraulic cement contains inexpensive, well-known, non-toxic, natural SCM and chemicals, which undergo exothermic aqueous cement formation reactions to provide improved cement embodiments; without horizontal kilning. The preferred SCM contains reactive aluminosilicate lattices and less amorphous alumina and silica. Calcium oxide reacts with the alumina in the SCM first to form calcium aluminosilicate lattice and calcium aluminate cements. This will overheat the reaction and boil the water off when all of the incident alumina is consumed. Therefore, aluminum sulfate is added to react with the calcium oxide and form more calcium aluminate cement. As the calcium oxide reacts with the aluminum sulfate, sulfates are released back into the pour solution and recombine as sulfuric acid. Sodium hydroxide is added to maintain an elevated pH. This forces the calcium oxide, aluminosilicate lattices, alumina and aluminum reaction to complete; while the water partially quenches the exothermic reaction. Also, the SCM is cleaved by the sulfuric acid and sodium hydroxide interaction, thereby releasing all of the available aluminosilicate lattices and alumina into the pour solution to react with calcium oxide. The aqueous cement formation reaction is covered, insulated to trap the heat of formation, sequestered, then uncovered, dehydrated and sized prior to use as hydraulic cement. The cement is friable, electrostatic and non-toxic. Therefore, it sizes easily and creates very little dust during processing and handling. It is half as dense and twice as soluble as Portland cement. The novel hydraulic cement can then be mixed with aggregate and water, placed and cured to provide improved concrete, mortar and grout placements. The novel cement is soluble to hydrate, then becomes hydrophobic during cure. The bonding of the calcium aluminosilicate lattice hydrate cement is provided by novel ionic wicking and calcium aluminum silica hydrate bonding. Greenhouse gasses are absorbed during cure and carbonation of the cementitious bonds lock them into place. This is a reversible process for recycling at low temperature. The novel concrete, mortar and grout embodiments can be mixed, placed and cured using industry standard equipment, additives, modifiers and practices. And, they mix, place, cure and gain strength similar to standard concrete, mortar and grout.

The novel hydraulic concrete embodiments contain inexpensive, well-known, non-toxic, natural SCM and chemicals, which undergo exothermic aqueous cement formation reactions, with aggregate present, to provide novel concrete placements; without horizontal kilning. Cement formation reactions occur during the mixing of chemicals, SCM, aggregate and water to promote homogeneity. Mixing, placement, set and cure methods are consistent and repeatable to provide improved properties in harsh environments and for challenging applications. The formulas and methods of the novel concrete embodiments can be adjusted to accommodate any clean aggregate, and for any construction application, including saltwater marine placements. The novel concrete, mortar and grout embodiments can be mixed, placed and cured using industry standard equipment, additives, modifiers and practices. And, they mix, place, cure and gain strength similar to standard concrete, mortar and grout.

Novel hydraulic concrete embodiments for use with hard aggregate contain natural SCM with more amorphous alumina and silica and no aluminosilicate lattices. They are reacted with calcium oxide in exothermic aqueous cement formation reactions. Calcium oxide reacts with the alumina first to form calcium aluminate cement. This will overheat the reaction and boil the water off when all of the incident alumina is consumed. Therefore, an aluminum sulfate, aluminum hydroxide and expanded perlite fines premixture is added to quench the reaction by forming more calcium aluminate cement. However, as calcium oxide reacts with the aluminum sulfate, sulfates are released into the pour solution and recombine into sulfuric acid. Sodium hydroxide is added to maintain an elevated pH and force the calcium oxide, alumina, and aluminum reaction to complete; instead of creating excess heat energy. Also, the SCM is cleaved by the sulfuric acid and sodium hydroxide interaction, thereby releasing all of the available alumina into the pour solution to react with calcium oxide. The calcium aluminate cements then react with amorphous and quasi-crystalline silica in the SCM and on the surface of the reactive aggregate during cure to gain strength. Calcium aluminum silica hydrate cement forms, then reacts with greenhouse gasses in the surrounding environment to form networks of calcium aluminum silica carbonate cement and aggregate concrete.

Novel hydraulic concrete embodiments for use in marine applications contain natural SCM with more amorphous alumina and silica and no aluminosilicate lattices. The SCM is reacted with calcium oxide in exothermic aqueous cement formation reactions. As the incident alumina and aluminum sulfate are consumed, sulfates are released back into the pour solution and recombine as sulfuric acid. No sodium hydroxide is present, therefore the pH plummets and a delayed exothermic cement formation reaction occurs; after placement. The SCM is consumed whole during the intense exothermic reaction. Aluminum calcium silica hydrate cement forms. Strength is gained quickly, which minimizes washout. Copious amounts of greenhouse gasses are absorbed from the surrounding water to form aluminum calcium silica carbonate cement and aggregate concrete. The thermal, physical and chemical stresses experienced during the reaction make it necessary to use softer aggregate and submersion in water for cooling during set and cure. Alternatively, the cementitious mixture and aggregate can be mixed, packed into a semi-permeable container, and submerged to cure. Both processes can be used for concrete precasting applications. And, any form of novel marine hydraulic concrete can be cured in saltwater without deleterious effect.

Novel hydraulic concrete embodiments for use with soft aggregate, on land, contain natural SCM with less amorphous alumina and silica. They are reacted with calcium oxide in exothermic aqueous cement formation reactions. Calcium oxide reacts with the alumina first to form calcium aluminate cement. This reaction creates heat and begins to boil the water off when all of the incident alumina is consumed. Therefore, aluminum sulfate is added to react with the calcium oxide to form more calcium aluminate cement. However, as calcium oxide reacts with the aluminum sulfate, sulfates are released into the pour solution and recombine as sulfuric acid. More sodium hydroxide is added to maintain an elevated pH and force the calcium oxide, alumina, and aluminum reaction to complete; instead of creating excess heat energy. Also, the SCM is cleaved by the sulfuric acid and sodium hydroxide interaction, thereby releasing all of the available alumina into the pour solution to react with the calcium oxide. When pumice is used as the SCM, a significant amount of expanded perlite fines must be substituted for the sodium hydroxide; to provide the correct pH and stoichiometry of quasi-crystalline and amorphous alumina and silica. This makes use of a nuisance material that is currently being disposed of at great cost. When zeolite is used as the SCM, no expanded perlite fines can be added. Zeolite already contains the correct stoichiometry of quasi-crystalline and amorphous alumina and silica, in reactive lattices, which require the additional sodium hydroxide to cleave. The calcium aluminate and aluminosilicate cements then react with amorphous and quasi-crystalline silica in the SCM and on the surface of the aggregate to form calcium aluminum silica hydrate cement, which then absorbs copious amounts of greenhouse gasses from the surrounding environment to form networks of calcium aluminum silica carbonate cement and aggregate concrete. The pot life is extended for ease of placement. The novel concrete with soft aggregate embodiments gain strength slower, however load-bearing strength can still be achieved in 28 days; while using waste aggregate, common SCM, less expensive chemicals, and nuisance byproducts.

The following examples are not intended to limit the scope of the current invention in any way and can be scaled to any size:

### Example 1: Hard Aggregate Concrete

This formula can be used with a wide variety of inert and reactive, standard, and lightweight aggregate. Place 4800 grams of standard ½ inch rock aggregate in a 5-gallon bucket. Add 2400 grams of standard ⅛ sand aggregate. Quickly and carefully add 540 grams of pulverized Graymont calcium oxide, 44 grams of technical grade aluminum hydroxide, 1 gram of Hess pumice expanded perlite fines, 15 grams of technical sodium hydroxide, 1620 grams of Hess pumice NCS3, 180 grams of technical grade aluminum sulfate, and 48 grams KAO PSD21 water reducer. Mix all of the ingredients well while dry by hand with a spatula then add 1200 grams of municipal tap water and continue mixing with a ½ inch drill and standard mud mixer attachment. This formula produces a slight amount of heat initially, then gives a 10-15 minute pot life for mixing and placement. Hard aggregate concrete embodiments can be poured, molded, sprayed, cast, or otherwise placed. This is free-flowing, self-consolidating, homogeneous, dimensionally stable material.

### Example 1A: Hard, Large Aggregate Concrete

This formula can be used with large inert and reactive, standard and lightweight aggregate. Place 4800 grams of standard 1-inch rock aggregate in a 5-gallon bucket. Add 2400 grams of standard ⅛-sand aggregate. Quickly and carefully add 540 grams of pulverized Graymont calcium oxide, 49 grams of technical grade aluminum hydroxide, 1 gram of Hess pumice expanded perlite fines, 10 grams of technical grade sodium hydroxide, 1620 grams of Hess pumice NCS3, 180 grams of technical grade aluminum sulfate, and 48 grams KAO PSD21 water reducer. Mix all of the ingredients well with a spatula while dry then add 1200 grams of municipal tap water and continue mixing with a ½ inch drill and mud mixer attachment. This formula produces a slight amount of heat initially, then gives a 10-15 minute pot life for mixing and placement. Large, hard aggregate synthetic concrete embodiments can be poured, molded, cast, or otherwise placed. This is free-flowing, self-consolidating, homogeneous, dimensionally stable material.

### Example 1B: Hard, Small Aggregate Concrete

This formula can be used with small inert and reactive, standard and lightweight aggregate. Place 7200 grams of Utelite fines ⅛-aggregate in a 5-gallon bucket. Quickly and carefully add 540 grams of pulverized Graymont calcium oxide, 41 grams of technical grade aluminum hydroxide, 1 gram of Hess pumice expanded perlite fines, 18 grams of technical grade sodium hydroxide, 1620 grams of Hess pumice NCS3, 180 grams of technical grade aluminum sulfate, and 48 grams KAO PSD21 water reducer. Mix all of the ingredients well with a spatula while dry then add 1400 grams of municipal tap water and continue mixing with a ½ inch drill and mud mixer attachment. This formula produces a slight amount of heat initially, then gives a 10-15 minute pot life for mixing and placement. Small, hard aggregate concrete embodiments can be poured, molded, sprayed, cast, or otherwise placed. This is free-flowing, self-consolidating, homogeneous, dimensionally stable material.

### Example 2: Marine Concrete

This formula can be used with a wide variety of non-standard aggregate. Place 7200 grams of ½-inch Hess waste pumice in a 5-gallon bucket. Quickly and carefully add 540 grams of pulverized Graymont calcium oxide, 60 grams of technical grade aluminum hydroxide, 1620 grams of Hess pumice NCS3, 180 grams of aluminum sulfate and 48 grams of KAO PSD21 water reducer. Mix all of the ingredients well with a spatula then add 1400 grams of municipal tap water and continue mixing with a ½ inch drill and a mud mixer attachment, then place underwater using a tremie system or pump. This formula and method produces a slight amount of heat initially, then gives a 5-10 minute pot life for mixing and placement. Marine concrete embodiments can also be used for precasting.

### Example 3: Pumice Concrete

This formula can be used with a wide variety of non-standard aggregate. Place 4800 grams of ½-inch Hess waste pumice in a 5-gallon bucket. Quickly and carefully add 360 grams of pulverized Graymont calcium oxide, 30 grams of technical grade sodium hydroxide, 10 grams of Hess pumice expanded perlite fines, 1080 grams of Hess NCS3 pumice, 120 grams of technical grade aluminum sulfate, 32 grams of KAO PSD21 water reducer, and 12 grams of Drycryl DP-2903. Mix all the ingredients well while dry with a spatula then add 1400 grams of municipal tap water and continue mixing with a ½ inch drill and mud mixer attachment. This formula produces a slight amount of heat initially, then gives a 20-30 minute pot life for mixing and placement. There is more quasi-crystalline alumina from the expanded perlite fines and more sodium hydroxide present. Therefore, strength is gained slower than in the hard aggregate formulas, through a sterically enhanced mechanism. However, load-bearing strength can still be achieved in 28 days. Soft aggregate concrete embodiments can be poured, molded, sprayed, cast, or otherwise placed. This is free-flowing, self-consolidating, homogeneous, dimensionally stable material.

### Example 4: Zeolite Concrete

This formula can be used with a wide variety of non-standard aggregate. Place 4800 grams of ½-inch Hess waste pumice in a 5-gallon bucket. Quickly and carefully add 360 grams of pulverized Graymont calcium oxide, 120 grams of technical grade aluminum sulfate, 40 grams of technical grade sodium hydroxide, 1080 grams of St Cloud Winston −325 zeolite, and 32 grams of KAO PSD21 water reducer. Mix all the ingredients well while dry with a spatula then add 1400 grams of municipal tap water and continue mixing with a ½ inch drill and mud mixer attachment. This formula produces a slight amount of heat initially, then gives a 20-30 minute pot life for mixing and placement. There is more quasi-crystalline alumina, aluminosilicate lattices, and more sodium hydroxide present. Therefore, strength is gained like in the soft aggregate embodiment, through a sterically enhanced mechanism. Load-bearing strength can still be achieved in 28 days. Zeolite concrete embodiments can be poured, molded, sprayed, cast, or otherwise placed. This is free-flowing, self-consolidating, homogeneous, dimensionally stable material.

### Example 7: Novel Cement

This formula prefers fine, high calcium, low sodium clinoptilolite, and high calcium quicklime. Place 2160 grams of St Cloud Winston −325 zeolite in a 5-gallon bucket. Quickly and carefully add 80 grams of technical grade sodium hydroxide, 240 grams of technical grade aluminum sulfate, and 720 grams of pulverized Graymont calcium oxide. Hand mix all the ingredients together well while dry with a spatula then add 4200 grams of municipal tap water and switch to mixing with a stick blender or other type of high-shear mixer. Mix for 5-10 minutes while scraping the sides until it is homogeneous and steaming hot. Pull the mixer and cover well. Insulate the bucket to trap the heat of formation and sequester it in a warm place for 30 days. Remove the cover, break it into chunks, then dehydrate completely, including all of the bound waters. Powderize the dried cement to 45 microns or less prior to use. Because the cement is light and friable, it is easy to powderize. Because it is electrostatic, minimal dust is created during processing. The novel cement can be used with a wide variety of soft and hard aggregate to provide improved concrete, mortar, and grout embodiments.

### Example 8: Novel Cement, Concrete, Mortar, and Grout Embodiments

Place 450 grams of ½ inch Hess waste pumice and 150 grams of Hess pumice ⅛-inch pumice sand in a 2-gallon bucket. Add 200 grams of the novel cement, 4 grams of KAO 21PSD, and 8 grams of Drycryl DP-2903. Mix the ingredients well while dry with a spatula, then add 220 grams of municipal water and continue mixing with a Mainstays corded hand mixer. This concrete or heavy mortar embodiment has a 10-15 minute pot life and can be cast, sprayed, troweled or otherwise placed. This is free-flowing, self-consolidating, homogeneous, dimensionally stable material.

Place 600 grams of Utelite fines ⅛-inch sand in a 2-gallon bucket. Add 200 grams of the novel cement, 4 grams of KAO 21PSD, and 8 grams of Drycryl DP-2903. Mix the ingredients well while dry with a spatula, then add 200 grams of municipal water and continue mixing with a Mainstays corded hand mixer. This concrete or mortar embodiment has a 10-15 minute pot life and can be cast, sprayed, troweled, or otherwise placed. This is free-flowing, self-consolidating, homogeneous, dimensionally stable material.

Place 600 grams of screened ⅛-inch masonry sand in a 2-gallon bucket. Add 200 grams of the novel cement, 4 grams of KAO 21PSD, and 8 grams of Drycryl DP-2903. Mix the ingredients well while dry with a spatula, then add 180 grams of municipal water and continue mixing with a Mainstays corded hand mixer. This concrete or mortar embodiment has a 10-15 minute pot life and can be cast, sprayed, troweled, or otherwise placed. This is free-flowing, self-consolidating, homogeneous, dimensionally stable material.

Place 600 grams of Hess waste pumice ⅛-inch sand in a 2-gallon bucket. Add 200 grams of the novel cement, 4 grams of KAO 21PSD, and 8 grams of Drycryl DP-2903. Mix the ingredients well while dry with a spatula, then add 230 grams of municipal water and continue mixing with a Mainstays corded hand mixer. This mortar composition has a 10-15 minute pot life and can be pointed, troweled, sprayed, cast, or otherwise placed. This is free-flowing, self-consolidating, homogeneous, dimensionally stable material.

Place 600 grams of Hess waste pumice ⅛-inch sand in a 2-gallon bucket. Add 200 grams of the novel cement, 2 grams of KAO 21PSD, and 8 grams of Drycryl DP-2903. Mix the ingredients well while dry with a spatula, then add 250 grams of municipal water and continue mixing with a Mainstays corded hand mixer. This mortar or grout embodiment has a 10-15 minute pot life and can be pointed, sprayed, or troweled into place. This is free-flowing, homogeneous, dimensionally stable material.

Place 200 grams of Hess NCS3 pumice in a 2-gallon bucket. Add 200 grams of the novel cement. Mix the ingredients well while dry with a spatula, then add 200 grams of municipal water and continue mixing with a stick blender or other high-shear mixer. This soil-stabilizing grout composition has a 20-30 minute pot life and can be injected, sprayed, or pumped into place. This is free-flowing, homogeneous material.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. Hydraulic concrete for construction, the concrete prepared by a method comprising the steps of:
adding supplementary cementitious material (SCM); and
adding calcium oxide, aluminum sulfate, and an aluminum hydroxide, sodium hydroxide and expanded perlite fines premixture, with mixing, to obtain a cementitious mixture;
adding aggregates to the cementitious mixture, with mixing; and
adding water, with mixing or submersion, to obtain hydraulic concrete.

2. The hydraulic concrete according to claim 1, wherein the SCM is selected from a group consisting of fly ash, ground blast furnace slag, densified silicon dioxide, pumice, zeolite, volcanic tuff, diatomaceous earth, perlite, vermiculite, pozzolans, vitreous materials, or any combinations thereof, wherein the SCM is sized to 0-100 microns before addition.

3. The hydraulic concrete according to claim 1, wherein the calcium oxide is selected from a group consisting of quicklime, magnesium oxide, dolomitic quicklime, lime, lyme, pulverized quicklime, micronized calcium oxide, technical grade calcium oxide, laboratory grade calcium oxide, pharmaceutical grade calcium oxide and any other type or form of calcium oxide or combination thereof.

4. The hydraulic concrete according to claim 1, wherein the stoichiometry of aluminum hydroxide, sodium hydroxide and expanded perlite fines in the premixture can be adjusted to accommodate any aggregate type or size, and for any construction application, including saltwater marine placements.

5. The hydraulic concrete according to claim 1, wherein the cementitious mixture by weight:
SCM: 50-90%,
calcium oxide: 5-50%,
aluminum sulfate: 2-20%,
aluminum hydroxide: 0-15%,
sodium hydroxide: 0-10%, and
expanded perlite fines: 0-5%.

6. The hydraulic concrete according to claim 1, wherein the ingredients of the cementitious mixture are combined less than 10 days prior to aggregate addition, wherein the aggregate to cementitious mixture ratio by weight: 0-10.

7. The hydraulic concrete according to claim 1, wherein the water is selected from a group including tap water, spring water, municipal water, purified water, reverse osmosis water, distilled water, brackish water or almost any other form of clean and clear water, wherein the water to cementitious mixture ratio by weight: 0.2-2, wherein the concrete can be mixed, placed and cured using industry standard equipment and practices.

8. The hydraulic concrete according to claim 1, wherein another method comprises the steps of mixing the cementitious mixture with aggregate and water to obtain a concrete pour solution, wherein the concrete is placed underwater using a tremie or pump system, wherein the concrete can be cured in fresh or saltwater, wherein the forming concrete rapidly cures to minimize washout, wherein this process can be used for precasting.

9. The hydraulic concrete embodiments according to claim 1, wherein KAO 21PSD water reducer, DOW Drycryl DP-2903 acrylic, or any other type or form of water reducer, plasticizer, superplasticizer, extender, curing aid, latex, acrylic, additive, modifier, formulation aid, pigment, enhancement or any combination thereof can be used in conjunction with the novel concrete formulations.

10. The hydraulic concrete according to claim 1, wherein another method comprises the steps of mixing the cementitious mixture and aggregate together less than 10 days before placement, wherein they are packed tightly into a semipermeable container, wherein they are submerged in fresh or saltwater to cure, wherein this process can be used for precasting.

11. Hydraulic cement for construction, the cement is prepared by a method comprising the steps of:
adding SCM; and
adding calcium oxide, aluminum sulfate, and sodium hydroxide, with mixing, to obtain a cementitious mixture;
adding water, with mixing, to initiate an cement formation reaction; and
covering, insulating and sequestering the aqueous reaction; and
uncovering, dehydrating and sizing the novel cement.

12. The hydraulic cement according to claim 11, wherein the SCM is selected from a group consisting of fly ash, ground blast furnace slag, densified silicon dioxide, pumice, zeolite, volcanic tuff, diatomaceous earth, perlite, vermiculite, pozzolan, vitreous materials, or any combination thereof, wherein the SCM is sized to 1-100 microns before addition.

13. The hydraulic cement according to claim 11, wherein the calcium oxide is selected from a group consisting of quicklime, magnesium oxide, dolomitic quicklime, lime, lyme, pulverized quicklime, micronized calcium oxide, technical grade calcium oxide, laboratory grade calcium oxide, pharmaceutical grade calcium oxide and any other type or form of calcium oxide or combination thereof.

14. The hydraulic cement according to claim 11, wherein the cementitious mixture by weight:
SCM: 50-90%,
calcium oxide: 5-50%,
aluminum sulfate: 2-20%, and
sodium hydroxide: 1-10%.

15. The hydraulic cement according to claim 11, wherein the cementitious mixture ingredients are combined less than 10 days prior to water addition, wherein the water is selected from a group including tap water, municipal water, purified water, reverse osmosis water, spring water, distilled water, brackish water or almost any other form of clean and clear water, wherein the cementitious mixture to water ratio by weight: 0.2-2.

16. The hydraulic cement according to claim 11, wherein the method comprises the steps of mixing the aqueous cement formation reaction for 1-100 minutes, wherein the reaction is covered, insulated and sequestered at 50 degrees Fahrenheit or higher for 1-100 days, wherein the cementitious material is uncovered, dehydrated and sized to 1-100 microns prior to use as cement.

17. Novel hydraulic concrete, mortar and grout embodiments for construction are prepared by a method comprising the steps of:
adding the novel cement and aggregate, with mixing; and
adding water, with mixing;
to obtain novel concrete, mortar and grout embodiments.

18. The novel concrete, mortar and grout embodiments according to claim 17, wherein any size of pumice, zeolite, chalkstone, sea shells, terracotta, low-fired brick or any other type or combination of clean aggregate with a compressive strength of generally 1000 psi or less can be used, wherein % inch or smaller limestone, granite, basalt, expanded shale or any other type or combination of hard aggregate with a compressive strength of generally 2000 psi or greater can be used, wherein the aggregate to cement ratio by weight: 0-10.

19. The novel concrete, mortar and grout embodiments according to claim 17, wherein the water is selected from a group including tap water, municipal water, purified water, reverse osmosis water, spring water, distilled water, brackish water or almost any other form of clean and clear water, wherein the cement to water ratio by weight: 0.2-2, wherein the embodiments can be mixed, placed and cured using industry standard equipment and practices.

20. The novel concrete, mortar and grout embodiments according to claim 17, wherein KAO 21PSD water reducer, DOW Drycryl DP-2903 acrylic, or any other type or form of water reducer, plasticizer, superplasticizer, extender, curing aid, latex, acrylic, additive, modifier, formulation aid, pigment, enhancement or any combination thereof can be used in conjunction with the novel concrete, mortar and grout formulations.
